(19) United States
(12) Patent Application Publication
(10) Pub. No.: US 2013/0222535 A1
(43) Pub. Date: Aug. 29, 2013

(54) REDUCING VISIBILITY OF 3D NOISE

(71) Applicants: Reinier Klein Gunnewiek, Utrecht (NL); Wilhelmus Hendrikus Alfonsus Bruls, Eindhoven (NL)

(72) Inventors: Reinier Klein Gunnewiek, Utrecht (NL); Wilhelmus Hendrikus Alfonsus Bruls, Eindhoven (NL)

(73) Assignee: KONINKLIJKE PHILIPS ELECTRONICS N.V., EINDHOVEN (NL)

(21) Appl. No.: 13/638,638

(22) PCT Filed: Mar. 31, 2011
(86) PCT No.: PCT/IB2011/051383

§ 371 Date: Mar. 5, 2013

(30) Foreign Application Priority Data
Apr. 6, 2010 (EP) 10159104.8

(51) Int. Cl. H04N 13/00

(52) U.S. Cl. CPC H04N 13/0007
USPC 348/43

(57) ABSTRACT

A 3D video device (40,50) is provided for processing a three dimensional [3D] video signal for avoiding visual disturbances during displaying on a 3D display (63). The 3D video signal comprises a left view and a right view for generating a 3D effect. The invention involves recognizing and solving a so-called dirty window effect, i.e. the problem that correlation between noise in both views results in the 3D noise being perceived on a particular depth. The video processor (42,52,53) is arranged for processing the 3D video data in dependence of at least one amount of visual disturbances to be expected during displaying of the 3D video data due to correlation of coding noise between said views for reducing said correlation of coding noise. The device has transfer means (46,55) for transferring the processed 3D video data for displaying on the 3D display. Also a 3D video signal (41) and a record carrier are provided.

### FIELD OF THE INVENTION

The invention relates to a method of processing a three dimensional [3D] video signal for avoiding visual disturbances during displaying on a 3D display, the method comprising receiving the 3D video signal representing 3D video data comprising at least a left view and a right view to be displayed for respective eyes of a viewer for generating a 3D effect.

The invention further relates to a 3D video device, a 3D video signal, a record carrier and a computer program product.

The invention relates to the field of processing 3D video data to improve rendering on a 3D display device by reducing visibility of 3D noise.

### BACKGROUND OF THE INVENTION

A vastly growing number of productions from the entertainment industry are aiming at 3D movie theatres. These productions use a two-view format (a left view and a right view to be displayed for respective eyes of a viewer for generating a 3D effect), primarily intended for eye-wear assisted viewing. There is interest from the industry to bring these 3D productions to the home. Currently, a first standard for distributing stereoscopic content via optical record carriers such as Blu-ray Disc (BD) is in its final state. From the broadcasting industry there is also interest in bringing 3D content to the home. The format that will be used, certainly in the early stage, will be the commonly used stereo format.

Devices for generating 2D video data are known, for example video servers, broadcasters, or authoring devices. Currently similar 3D video devices for providing 3D image data are available, and complementary 3D video devices for rendering the 3D video data are being proposed, like players for optical discs or set top boxes which render received 3D video signals. The 3D video device may be coupled to a display device like a TV set or monitor for transferring the 3D video data via a suitable interface, preferably a high-speed digital interface like HDMI. The 3D display may also be integrated with the 3D video device, e.g. a television (TV) having a receiving section and a 3D display.

The document “Stereo Video Coding System with Hybrid Coding based on Joint Prediction Scheme” by Li-Fu Ding et al, IEEE 0-7803-8834-8/05 page 6082-6085 describes an example of a coding scheme for 3D video data having a left view and a right view. Another example of 3D content is stereoscopic content having a plurality of right eye views and left eye views. The encoding is arranged for dependently encoding one view (e.g. the right view) based on encoding the other view independently, as illustrated in FIGS. 1 and 2 of the document. The described coding scheme, and similar coding techniques, are efficient in the sense that the required bit rate is reduced due to using redundancy in both views.

### SUMMARY OF THE INVENTION

In order to bring the above stereoscopic content to the home the 3D video data will be compressed according to a predefined format. Since the resources on a broadcasting channel, and to a lesser extend on BD, are limited a high compression factor will be applied. Due to the relatively high compression ratio various artifacts and other disturbances may occur, in this document further referred to as coding noise.

It is an object of the invention to provide video processing for reducing visual disturbances due to coding noise during displaying on a 3D display.

For this purpose, according to a first aspect of the invention, the method as described in the opening paragraph comprises:

processing the 3D video data in dependence of at least one amount of visual disturbances to be expected during displaying of the 3D video data on a 3D display (63) due to correlation of coding noise between said views for reducing the correlation of coding noise, and

transferring the processed 3D video data for displaying on the 3D display.

For this purpose, according to a second aspect of the invention, the 3D video device for processing a 3D video signal for avoiding visual disturbances during displaying on a 3D display, comprises input means for receiving the 3D video signal representing 3D video data comprising at least a left view and a right view to be displayed for respective eyes of a viewer for generating a 3D effect, a video processor arranged for processing the 3D video data in dependence of at least one amount of visual disturbances to be expected during displaying of the 3D video data on a 3D display due to correlation of coding noise between said views for reducing said correlation of coding noise, and transfer means for transferring the processed 3D video data for displaying on the 3D display.

For this purpose, according to a further aspect of the invention, the 3D video signal comprises 3D video data comprising at least a left view and a right view to be displayed for respective eyes of a viewer for generating a 3D effect and 3D noise metadata indicative of at least one amount of visual disturbances to be expected during displaying of the 3D video data on a 3D display due to correlation of coding noise between said views, the signal being for transferring the 3D video data to a 3D video device for therein enabling processing the 3D video data according to the 3D noise metadata for reducing said correlation of coding noise.

The measures have the effect of reducing the correlation of the coding noise in the left view and the right view, when displayed on a 3D display for a viewer. Correlation between noise in both views results in the noise being perceived as, e.g. a smudge or other disturbances positioned at a particular depth. Advantageously due to reducing the correlation, any such disturbances will be less visible and less annoying to the viewer at the 3D display.

The invention is also based on the following recognition. The prior art document describes dependently encoding both views. Dependent coding of the views is commonly used for 3D video data. Since the resources on a 3D data channel are limited a compression factor will be applied that is relatively high, i.e. as high as possible without coding noise being too much visible according to the quality criteria of the source or author of the 3D video data. Hence, in practice, some coding noise will be present. The inventors have observed that the coding artifacts in stereo coding will be perceived at a specific depth, which they have called a dirty window effect. The effect occurs due to the coding noise being correlated in both views. In practice the stereoscopic content appears to be observed through a dirty window, as a veil of artifacts is floating in front of or sometimes even indenting forward objects in the scene, i.e. floating at a single perceived depth position. The depth position of said dirty window is equal to the depth position of objects having the same position in the left and right view, i.e. normally at screen depth. If the views have been shifted in horizontal direction, e.g. for compensating screen size effects or viewer distance (called base line shifting), the dirty window will also shift in depth direction, but remain visible at a different depth position.

The compression methods that will typically be used for 3D video data are block based. The block-grid and the block alignment will be fixed for both views. Although the left and the right view may be coded independently, to achieve better coding efficiency joint coding methods are commonly used. Joint coding methods try to exploit the correlation between the left and the right view. In order to obtain higher compression factors information present in both images may be coded only once, information may be encoded using spatial and/or temporal relations, and/or information in individual images which is unlikely to be perceived by an observer (perception based coding) is removed from the video signal. The removal of information; i.e. lossy coding, introduces coding noise, especially when high compression factors are applied. This coding noise can be visible as a range of artifacts ranging from mosquito noise to blocking artifacts. For block-based compression schemes, the coding noise is typically correlated to the block structure used by compression method.

The inventors have seen that, although coding artifacts such as mosquito noise may be hardly visible in individual 2D images, such artifacts can become visible when a left and right image of a stereo pair are viewed in combination. In stereoscopy different images are applied to each eye, the differences in the respective images effectively encodes depth information. In order to determine depth the human visual system interprets a horizontal offset (i.e. disparity) of an object in the left view and the corresponding object in the right view as providing an indication of the depth of the object. As such the human visual system we will interpret disparities for all objects in the left and right view and based thereon derive a depth ordering/depth impression of a scene. The human visual system however will do so for both objects in the actual images as well as for artifacts resulting from coding noise.

Typically, coding noise correlates to the block structure used while encoding. Generally this block structure is fixed at one and the same position for both the left view and the right view image. When coding artifacts occur at block boundaries, e.g. in case of blocking, these blocking artifacts will be visible at one and the same location in the left and right image. As a result the coding noise will be visible at zero disparity; i.e. at screen depth. When baseline shift between the left and the right is applied the dirty window will move alongside, but will remain visible.

In practice such artifacts appear to a viewer as if one is looking through a dirty window to the scene. When a joint coding method is used the coding noise will inherently be correlated. Unfortunately knowing the dirty window effect invokes seeing it, and being distracted by it.

As explained above, the dirty window problem arises from the correlated coding noise between the left and the right view. Therefore measures to solve this problem involve either avoiding or reducing the correlation at the encoding side or de-correlating the correlated coding noise at the decoding side. There are various ways to reduce or de-correlate 3D noise in both views, as described in the embodiments below.

In an embodiment the method comprises a step of encoding the 3D video data according to a transform based on blocks of video data and encoding parameters for said blocks, and a step of determining the at least one amount of visual disturbances to be expected for at least one respective block, and the step of processing comprises adjusting the encoding parameters for the respective block in dependence of the amount as determined for the respective block.

In an embodiment the device comprises an encoder for encoding the 3D video data according to a transform based on blocks of video data and encoding parameters for said blocks, and the video processor is arranged for determining the at least one amount of visual disturbances to be expected for at least one respective block, and for, in said processing, adjusting the encoding parameters for the respective block in dependence of the amount as determined for the respective block.

The effect is that the encoding is controlled in dependence of the amount of visual disturbances to be expected during display. The amount, and also the visibility of the expected 3D noise, may be based on the content of the 3D video data in the block, e.g. a complex image and or much movement or depth differences. In such blocks any coding noise will be less visible. On the other hand, in relatively quiet scene coding noise may be more annoying. Also, if the depth in the respective blocks is large (i.e. a lot of space behind the dirty window), the amount of visual disturbance is high due to high visibility of the dirty window having a lot of space behind it. Subsequently, if the amount is high, the coding parameters may be adjusted to reduce the coding noise in such blocks, thereby reducing said correlation, e.g. by locally increasing the available bit rate. Advantageously, the total bit rate can be more efficiently used, while reducing the dirty window effect in those blocks where it would be most visible.

In an embodiment the method comprises a step of decoding the 3D video data, and the step of processing comprises, after said decoding, adding dithering noise to at least one of the views for reducing said correlation.

In an embodiment the device comprises a decoder for decoding the 3D video data, and the video processor is arranged for, after said decoding, adding dithering noise to at least one of the views for reducing said correlation.

The dithering noise is added based on the amount of visual disturbances to be expected during display. The effect is that the correlation is reduced, although the total amount of noise is somewhat increased. Dithering noise can be added to the left and/or the right view. Experiments showed that adding dithering noise to either the left or the right view is sufficient to de-correlate the coding noise, and gives the best image quality.

In an embodiment the video processor is arranged for, after said decoding, adding dithering noise only to the view for the non-dominant eye of the viewer. The inventors have noted that the noise actually perceived is dependent on the specific view where noise is added. It seems that the dithering noise can be best applied to the non-dominant eye, being the left eye for the majority of the people. In practice the device may have a user setting, and/or test mode, to determine which eye is dominant.

In an embodiment of the method the method comprises generating 3D noise metadata indicative of the at least one amount, and the step of transferring comprises including the 3D noise metadata in a 3D video signal for transferring to a 3D video device for therein enabling processing according to the 3D noise metadata for reducing said correlation of coding noise. The effect is that additional 3D noise metadata is generated at the source which is to be used at the rendering side. For example, the noise metadata is based on encoding knowledge, such as the quantization step that has been used during coding. The 3D noise metadata is transferred to the decoding side, where it is applied for processing the 3D video data according to the 3D noise metadata for reducing said correlation of coding noise. For example, when the 3D noise metadata is indicative of the noise level in blocks of the image, the amount of dithering noise added during decoding to each block is determined based on the noise metadata. Advantageously the data of expected occurrence of coding noise is generated at the source of the 3D video data, i.e. only once where ample processing resources are available. Consequently, the processing at the decoder side, e.g. at the consumer premises, can be relatively cheap.

In an embodiment of the method the method comprises retrieving 3D noise metadata from the 3D video signal, the 3D noise metadata being indicative of the at least one amount, and the step of processing comprises processing the 3D video data according to the 3D noise metadata for reducing said correlation of coding noise.

In an embodiment the video processor is arranged for retrieving 3D noise metadata from the 3D video signal, the 3D noise metadata being indicative of the at least one amount, and for said processing by processing the 3D video data in dependence of the 3D noise metadata for reducing said correlation. In a further embodiment the device comprises a decoder arranged for decoding the 3D video data according to a transform based on blocks of video data and decoding parameters for said blocks, and the video processor is arranged for adding dithering noise to at least one of the blocks in dependence of the 3D noise metadata for reducing said correlation.

The effect is that the 3D noise metadata, generated as described above, is received with the 3D video signal, and subsequently retrieved and used to control the processing of the 3D video data for reducing said correlation. Advantageously the amount of disturbances to be expected is determined off-line, i.e. at the source side. In the further embodiment the amount of dithering noise is controlled for the respective blocks in dependence of the 3D noise metadata, thereby reducing the visual disturbances in parts of the image where they would have been most annoying.

In an embodiment the 3D video signal is comprised in a record carrier, e.g. embedded in a pattern of optically readable marks in a track. The effect is that the available data storage space is used more efficiently.

Further preferred embodiments of the method, 3D devices and signal according to the invention are given in the appended claims, disclosure of which is incorporated herein by reference.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows a device for processing 3D video data in a system for displaying 3D image data, such as video, graphics or other visual information,

FIG. 2 shows a 3D video processor for reducing correlation between views,

FIG. 3 shows 3D noise metadata in a private user data SEI message,

FIG. 4 shows a data structure for 3D noise metadata in a 3D video signal,

FIG. 5 shows 3D video data,

FIG. 6 shows 3D video data having 3D noise,

FIGS. 7A, 7B, 7C and 7D show respective details of 3D video data having 3D noise, and

FIG. 8 shows a schematic example of 3D noise.

In the Figures, elements which correspond to elements already described have the same reference numerals.

### DETAILED DESCRIPTION OF EMBODIMENTS

It is noted that the current invention may be used for any type of 3D video data that is based on multiple images (views) for the respective left and right eye of viewers. 3D video data is assumed to be available as electronic, digitally encoded, data. The current invention relates to such image data and processing of image data in the digital domain.

There are many different ways in which 3D video data may be formatted and transferred, called a 3D video format. Some formats are based on using a 2D channel to also carry the stereo information. For example the left and right view can be interlaced or can be placed side by side and above and under. These methods sacrifice resolution to carry the stereo information.

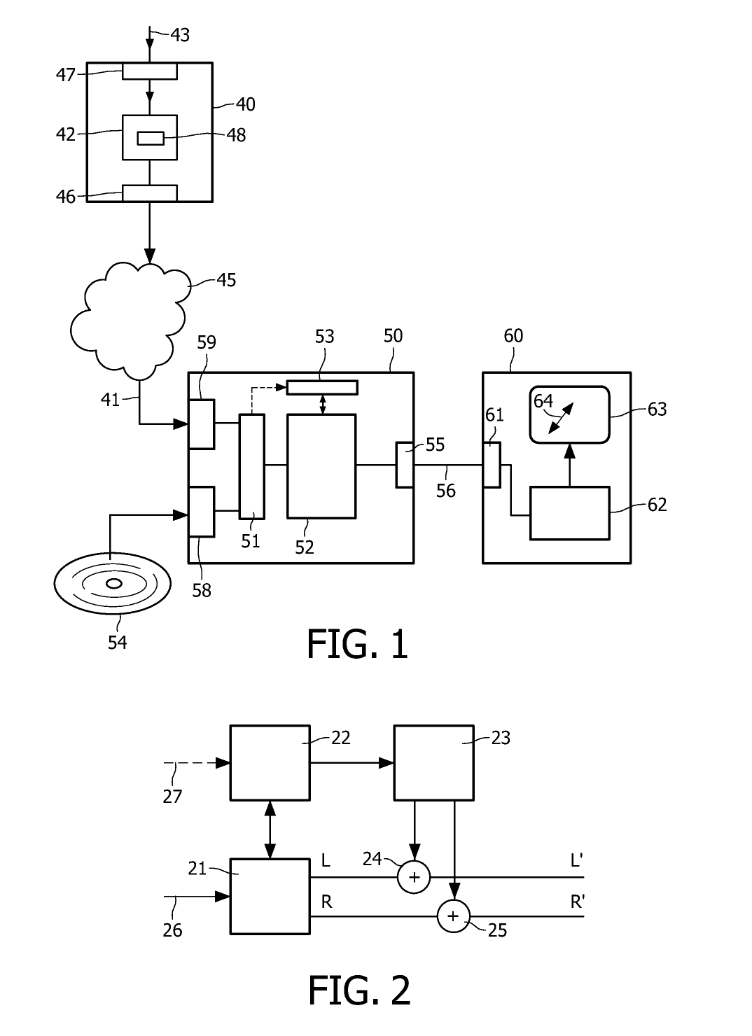

FIG. 1 shows a device for processing 3D video data in a system for displaying three dimensional (3D) image data, such as video, graphics or other visual information. A first 3D video device 40, called 3D source, provides and transfers a 3D video signal 41 to a further 3D video device 50, called 3D player, which is coupled to a 3D display device 60 for transferring a 3D display signal 56.

FIG. 1 further shows a record carrier 54 as a carrier of the 3D video signal. The record carrier is disc-shaped and has a track and a central hole. The track, constituted by a pattern of physically detectable marks, is arranged in accordance with a spiral or concentric pattern of turns constituting substantially parallel tracks on one or more information layers. The record carrier may be optically readable, called an optical disc, e.g. a CD, DVD or BD (Blu-ray Disc). The information is embodied on the information layer by the optically detectable marks along the track, e.g. pits and lands. The track structure also comprises position information, e.g. headers and addresses, for indication the location of units of information, usually called information blocks. The record carrier 54 carries information representing digitally encoded 3D image data like video, for example encoded according to the MPEG2 or MPEG4 encoding system, in a predefined recording format like the DVD or BD format.

The 3D source has a processing unit 42 for processing 3D video data, received via an input unit 47. The input 3D video data 43 may be available from a storage system, a recording studio, from 3D camera's, etc. A video processor 42 generates the 3D video signal 41 comprising the 3D video data. The source may be arranged for transferring the 3D video signal from the video processor via an output unit 46 and to a further 3D video device, or for providing a 3D video signal for distribution, e.g. via a record carrier. The 3D video signal is based on processing input 3D video data 43, e.g. by encoding and formatting the 3D video data according to a predefined format via an encoder 48.

The processor 42 for processing 3D video data is arranged for determining an amount of visual disturbances to be expected during displaying of the 3D video data on a 3D display due to correlation of coding noise between said views, and enables processing the 3D video data in dependence of the amount as determined for reducing said correlation of coding noise. The processor may be arranged for determining 3D noise metadata indicative of disturbances occurring in 3D video data when displayed, and for including the 3D noise metadata in the 3D video signal. Embodiments of the processing are described in further detail below.

The 3D source may be a server, a broadcaster, a recording device, or an authoring and/or production system for manufacturing optical record carriers like the Blu-ray Disc. Blu-ray Disc provides an interactive platform for distributing video for content creators. Information on the Blu-ray Disc format is available from the website of the Blu-ray Disc association in papers on the audio-visual application format, e.g. http://www.blu-raydisc.com/Assets/Downloadablefile/2b_bdrom_audiovisualapplication_{—}030 5-12955-15269.pdf. The production process of the optical record carrier further comprises the steps of providing a physical pattern of marks in tracks which pattern embodies the 3D video signal that may include 3D noise metadata, and subsequently shaping the material of the record carrier according to the pattern to provide the tracks of marks on at least one storage layer.

The 3D player device has an input unit 51 for receiving the 3D video signal 41. For example the device may include an optical disc unit 58 coupled to the input unit for retrieving the 3D video information from an optical record carrier 54 like a DVD or Blu-ray disc. Alternatively (or additionally), the 3D player device may include a network interface unit 59 for coupling to a network 45, for example the internet or a broadcast network, such device usually being called a set-top box. The 3D video signal may be retrieved from a remote website or media server as indicated by the 3D source 40. The 3D player may also be a satellite receiver, or a media player.

The 3D player device has a processing unit 52 coupled to the input unit 51 for processing the 3D information for generating a 3D display signal 56 to be transferred via an output interface unit 55 to the display device, e.g. a display signal according to the HDMI standard, see “High Definition Multimedia Interface; Specification Version 1.3a of Nov. 10 2006” available at http://hdmi.org/manufacturer/specification.aspx. The processing unit 52 is arranged for generating the image data included in the 3D display signal 56 for display on the display device 60.

The player device may have a further processing unit 53 for processing 3D video data arranged for determining 3D noise metadata indicative of disturbances occurring in 3D video data when displayed. The further processing unit 53 may be coupled to the input unit 51 for retrieving 3D noise metadata from the 3D video signal, and is coupled to the processing unit 52 for controlling the processing of the 3D video as described below. The 3D noise metadata may also be acquired via a separate channel, or may be generated locally based on processing the 3D video data.

The 3D display device 60 is for displaying 3D image data. The device has an input interface unit 61 for receiving the 3D display signal 56 including the 3D video data transferred from the 3D player 50. The transferred 3D video data is processed in processing unit 62 for displaying on a 3D display 63, for example a dual or lenticular LCD. The display device 60 may be any type of stereoscopic display, also called 3D display, and has a display depth range indicated by arrow 64.

The video processor in the 3D video device, i.e. the processor units 52,53 in the 3D video device 50, is arranged for executing the following functions for processing the 3D video signal for avoiding visual disturbances during displaying on a 3D display. The 3D video signal is received by the input means 51,58,59. The 3D video signal comprises the 3D video data in a digitally encoded, compressed format. The 3D video signal represents 3D video data comprising at least a left view and a right view to be displayed for respective eyes of a viewer for generating a 3D effect. The video processor may be arranged for determining an amount of visual disturbances to be expected during displaying of the 3D video data on a 3D display due to correlation of coding noise between said views. The video processor is arranged for processing the 3D video data in dependence of the amount for reducing said correlation of coding noise. Various techniques for reducing or avoiding said correlation are discussed below. The amount may also be preset by a viewer at a player or an author at a source, predetermined (e.g. for specific channels or media sources), estimated (e.g. based on the total bit rate of a medium or data channel), or fixed (e.g. in a low end application where the compression rate will always be low). Finally, the processed 3D video data is coupled to transfer means such as the output interface unit 55 for transferring the processed 3D video data for displaying on the 3D display.

In an embodiment the amount is derived based on the compression rate, bit rate and/or the resolution of the 3D video signal. For example, the quantization level may be monitored (Q-monitoring). In a more basic embodiment, determining the amount may be based on a predetermined threshold bit rate, or on a user setting. Furthermore, the amount may be determined based on calculating a visibility of 3D noise in dependence of the video content, e.g. in dependence of the complexity of the image and/or the amount of movement or depth differences. Depth may be derived from disparity estimation (which may be rather crude for this purpose) of from a depth map (if available). In complex images any coding noise will be less visible. On the other hand, in relatively quiet scene coding noise may be more annoying. Also, if the depth in the image is large (i.e. a lot of space behind the so-called dirty window), the amount of visual disturbance is high due to high visibility of the dirty window having a lot of space behind it. In practice a complexity or texture in a picture may be derived from high frequency components in the video signal, and the (average) depth in the picture, or areas or blocks thereof, may be monitored based on disparity estimation or other depth parameters. In addition, the amount may be determined for the total image, or for a few regions (e.g. upper and lower section for accommodating an upper section having a larger depth), or for a larger number of blocks (either predetermined, or dynamically assigned based on subdividing the picture according to expected visibility of 3D noise). Furthermore, a de-correlation pattern indicative of said amount may be provided by the encoder, or based on characteristics of the encoded signal, which pattern may be used during or after decoding to control the way and/or amount of de-correlation.

Reducing correlation between two images can be performed in various ways during encoding, decoding or after decoding the images. As such, various techniques for controlling correlation are known in the field of video processing. During encoding the encoding parameters may be adjusted to reduce correlation of artifacts and noise between the two views. For example, the quantization may be temporarily or locally controlled, and/or the overall bit rate may be varied. During decoding various filtering techniques may be applied, or parameters may be adjusted. For example, a de-blocking filter may be inserted and/or adjusted to reduce artifacts occurring due to a block based compression scheme. De-blocking or further filtering may be invoked only, or differently, for the dependently encoded view.

In an embodiment processing the 3D video data in dependence of the amount as determined for reducing said correlation of coding noise is performed by adjusting the above mentioned techniques for controlling correlation based on the amount. For example, the amount may be a fixed setting for a respective 3D video source or 3D video program. The fixed setting may be entered or adjusted by a user based on personal preferences, such as a setting for “reducing 3D noise” for specific video sources, video programs, TV channels, types of record carrier, or a general setting for the 3D video processing device. The amount may also dynamically determined, e.g. based on the total bit rate, quality and/or resolution of the 3D video data.

In an embodiment, the 3D video device is a source device 40 and comprises an encoder in the processor unit 42 for encoding the 3D video data according to a transform based on blocks of video data and encoding parameters for said blocks. Generally speaking compression may be performed using lossless and lossy techniques. Lossless techniques typically rely on entropy coding; however the compression gain feasible with lossless compression only is dependent on the entropy of the source signal. As a result the compression ratios achievable are typically insufficient for consumer applications. As a result lossy compression techniques have been developed wherein an input video stream is analyzed and information is coded in a manner such that information loss as perceived by a viewer is kept to a minimal; i.e. using so-called perception based coding.

Most common video compression schemes comprise a mix of both lossless and lossy coding. Many of such schemes comprise steps such as signal analysis, quantization and variable length encoding respectively. Various compression techniques may be applied ranging from discrete cosine transform (DCT), vector quantization (VQ), fractal compression, to discrete wavelet transform (DWT).

Discrete cosine transform based compression is a lossy compression algorithm that samples an image at regular intervals, analyzes the frequency components present in the sample, and discards those frequencies which do not affect the image as the human eye perceives it. DCT based compression forms the basis of standards such as JPEG, MPEG, H.261, and H.263.

The video processor 42 is arranged for determining the amount of visual disturbances by determining at least one amount of visual disturbances to be expected for at least one respective block. 3D noise may be caused by artifacts due to compression type used, such as DCT performed for blocks in the 3D picture. Subsequently in said processing, the video processor adjusts the encoding parameters for the respective block or area in dependence of the amount as determined for the respective block. For example, when a high amount is determined for a block, the quantization is adjusted. Alternatively, or additionally, an encoding grid such as the blocks may be used with an offset that dynamically changes to avoid having the artifacts occurring at the same location. Furthermore, a controllable de-blocking filter may be used in the encoder. As described in the introductory part, encoding a dependent right view may be based on independently encoded left view. When a high amount is determined for a particular image or period of the 3D image data, a less dependent encoding mode may be temporarily set, e.g. using in said Joint Prediction Scheme an I picture instead of a P picture depending on the other view.

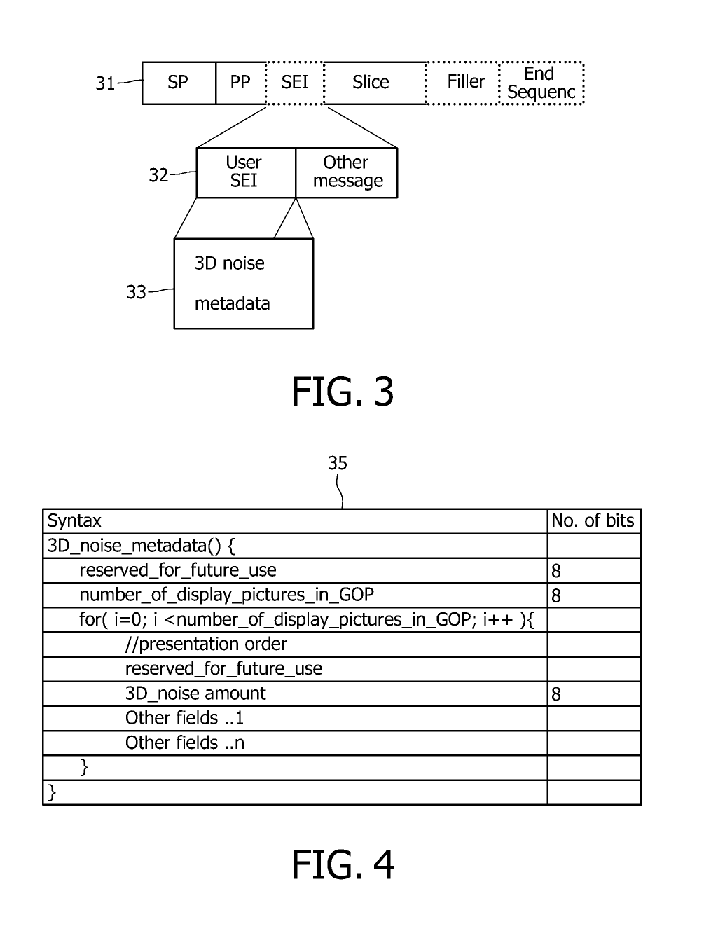

In an embodiment at least one of the views is shifted before encoding with respect to the grid used in the encoding in dependence of a common background of both views. Either one or both views are shifted horizontally by a shift parameter until the grid in both views has substantially the same position with respect to the background. After decoding the complementary reverse shift of the view(s) by the shift parameter must be applied. The shift parameter may be transferred with the 3D video signal, e.g. as 3D noise metadata as elucidated with reference to FIGS. 3 and 4 below. Effectively the 3D noise will now be moved to a depth position of the background, and therefore be less disturbing to the viewer. The shift may be determined per frame, or for a group of pictures, for a fragment of video between key frames, for a scene, or for a larger section or video program. The shift may also be preset to a value that moves the 3D noise always to a large distance behind the screen, e.g. infinity.

The amount, and also the visibility of the expected 3D noise, may further be based on the content of the 3D video data in the block, e.g. a complex image content and/or much movement or depth differences. In such blocks any coding noise will be less visible. On the other hand, in relatively quiet scene coding noise may be more annoying. Also, if the depth in the respective blocks is large (i.e. a lot of space behind the dirty window), the amount of visual disturbance is high due to high visibility of the dirty window having a lot of space behind it. Subsequently, if the amount is high, the coding parameters may be adjusted to reduce the coding noise is such blocks, thereby reducing said correlation, e.g. by locally increasing the available bit rate.

In an embodiment, the 3D video device is a player device 50 and the video processor 52 comprises a decoder for decoding the 3D video data. The video processor 52 is arranged for, after said decoding, adding dithering noise to at least one of the views for reducing said correlation.

FIG. 2 shows a 3D video processor for reducing correlation between views. An input 26 provides a 3D video signal to an decoder 21, which generates a left view L and a right view R. A detector 22 coupled to the decoder 21 is arranged for determining said amount of visual disturbances to be expected, e.g. based on decoding parameters of the 3D video signal from the decoder. The detector is coupled to a dithering noise generator 23 for controllably generating an amount of dithering noise to be added to the views. The noise is added to the view L by adder 24 for generating processed video data left view L′. The noise is added to the view R by adder 25 for generating processed video data left view R′. The dithering noise can be added to the left view L and/or the right view R. The experiments showed that adding dithering noise to either the left or the right view is sufficient to de-correlate the coding noise, and gives the best image quality.

The amount of dithering noise as controlled by the detector 22 may be fixed, based on a preset or predetermined amount of visual disturbances to be expected during display. The amount may also be dynamically determined similar to said determining at the encoder side described above, either for the total image, for sections of the image or for blocks. The dithering noise may correspondingly be added to the respective periods of areas of the image based on the amount as determined.

In a further embodiment of 3D video device, the video processor is arranged for, after said decoding, adding dithering noise only to the view for the non-dominant eye of the viewer. It seems that the dithering noise can be best applied to the non-dominant eye, being the left eye for the majority of the people. In practice the device may have a user setting, and/or test mode, to determine which eye is dominant for allowing the viewer to control to which view the dithering noise is to be added. It is noted that, in an embodiment, some dithering noise and/or additional de-blocking is always applied, e.g. to the left view. In such embodiment the amount of 3D noise is established once for a particular system or application, and the dithering and/or filtering is preset in dependence of said established amount.

In an embodiment the 3D video device is the source 40, and the video processor 42 is provided with a function, for said determining the amount of visual disturbances to be expected during display, of generating 3D noise metadata indicative of the at least one amount as determined. The 3D noise metadata may also be determined separately, e.g. in an authoring system or a post-processing facility, and/or transferred separately to the 3D player. Said amount of visual disturbances may be determined as described above, e.g. based on encoding knowledge, such as the quantization step that has been used during coding. Also further encoding parameters, like any pre-filtering or weighting tables used during encoding, may be included in the 3D noise metadata. The process of transferring may include the 3D noise metadata in a 3D video signal for transferring to a 3D video device for therein enabling processing according to the 3D noise metadata for reducing said correlation of coding noise.

A further extension of the 3D noise metadata is to define several regions in the video frame and to assign 3D noise metadata values specifically to that region. In an embodiment selecting a region is performed as follows. The display area is subdivided in multiple regions. Detecting the 3D noise metadata is performed for each region. For example the frame area is divided into 2 or more regions (e.g. horizontal stripes) and for each region the 3D noise ratio value is added to stream. This gives for freedom for the decoder for processing, e.g. adding dithering noise, depending also on the region.

The 3D noise metadata may be based on spatially filtering the 3D noise values of the multiple regions according to a spatial filter function in dependence of the region. In an example the display area is divided in blocks according to the encoding scheme. In each block the 3D noise to be expected is computed separately.

In an embodiment the 3D video signal, which comprises the 3D video data comprising at least a left view and a right view to be displayed for respective eyes of a viewer for generating a 3D effect, further includes the 3D noise metadata indicative of at least one amount of visual disturbances to be expected during displaying of the 3D video data on a 3D display due to correlation of coding noise between said views. In general, the signal is provided for transferring the 3D video data to a 3D video device for therein enabling processing the 3D video data according to the 3D noise metadata for reducing said correlation of coding noise. In practice, the 3D video signal carrying the 3D noise metadata, is distributed to viewers via any suitable medium, e.g. broadcast via TV transmission or satellite, or on a record carrier like optical discs. Hence the record carrier 54 then comprises the above 3D video signal including the 3D noise metadata.

In an embodiment the 3D video device is a 3D player 50 and the video processor 53 is arranged for determining the amount of visual disturbances by retrieving 3D noise metadata from the 3D video signal. The 3D noise metadata is indicative of said at least one amount of visual disturbances. The 3D video processor 52 is controlled for adjusting said processing by processing the 3D video data in dependence of the 3D noise metadata for reducing said correlation.

Alternatively to reducing the correlation in the 3D player 50 said processing is performed in an embodiment of the display device 60. The 3D video data, and optionally the 3D noise metadata, are transferred via the display signal 56, e.g. according to the HDMI standard. The processing unit 62 now performs any of the above functions for de-correlating the 3D video data on the 3D display. Hence the processing means 62 may be arranged for the corresponding functions as described for the processing means 52,53 in the player device. In a further embodiment the 3D player device and the 3D display device are integrated in a single device.

As described above the 3D noise metadata may be included in the 3D video signal. In one embodiment the 3D noise metadata is included in a user data message according to a predefined standard transmission format such as MPEG4, e.g. a signaling elementary stream information [SEI] message of a H.264 encoded stream. The method has the advantage that it is compatible with all systems that rely on the H.264/AVC coding standard (see e.g. ITU-T H.264 and ISO/IEC MPEG-4 AVC, i.e. ISO/IEC 14496-10 standards). New encoders/decoders could implement the new SEI message whilst existing ones would simply ignore them.

FIG. 3 shows 3D noise metadata in a private user data SEI message. A 3D video stream 31 is schematically indicated. One element in the stream is the signaling to indicate the parameters of the stream to the decoder, the so called signaling elementary stream information [SEI] message 32. More specifically the 3D noise metadata 33 could be stored in a user data container. The 3D noise metadata may include absolute amount of noise values, signal-to-noise ratio values or any other representation of 3D noise information.

FIG. 4 shows a data structure for 3D noise metadata in a 3D video signal. For example the video signal may be provided on a record carrier according to a predefined 3D format like Blu-ray Disc. The table shown in the Figure defines the syntax of the respective control data packets in the video stream, in particular a GOP structure map( ) which defines the 3D noise metadata for individual display pictures in a Group Of Picture (GOP) coded together. The data structure defines fields for 3D noise metadata 35. The fields may contain a 3D noise amount or ratio, or other 3D noise related parameters like decoding control parameters indicative of a coding grid and/or filtering. The structure may further be extended to provide more detailed 3D noise metadata as described above, e.g. for regions or blocks within the display pictures, providing 3D noise metadata for a period of time, etc.

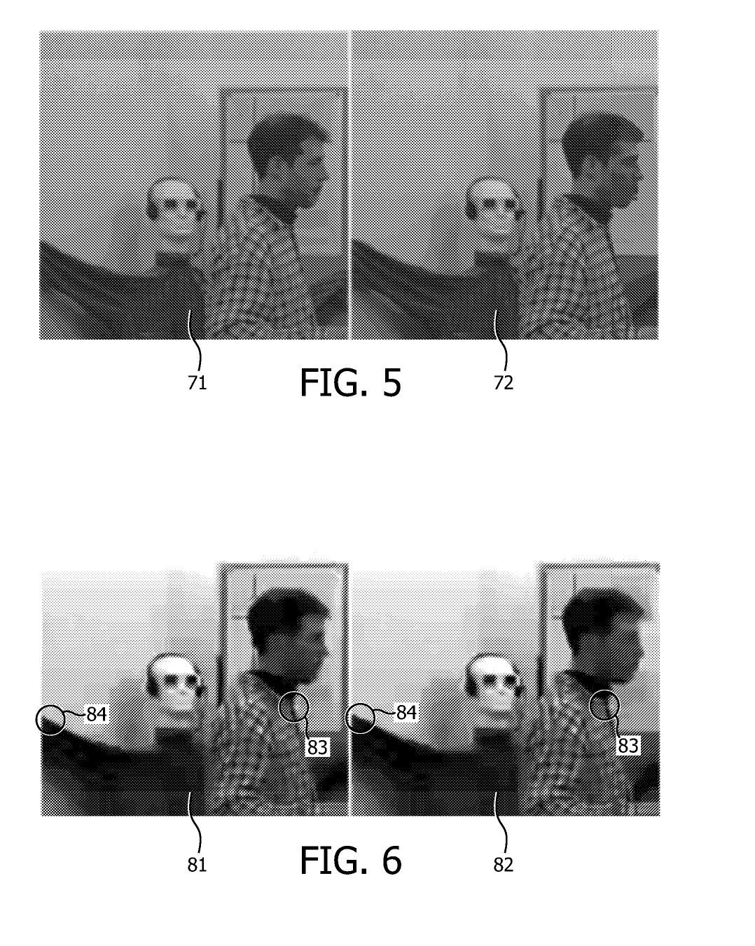

FIG. 5 shows 3D video data. The Figure shows a left view 71 and a right view 72 in of uncompressed high quality 3D video signal.

FIG. 6 shows 3D video data having 3D noise. The Figure shows a left view 81 and a right view 82 derived from the video data as shown in FIG. 5. The views are generated after first encoding the 3D video data by relatively strong compression at the source side, transfer via a 3D video signal and decoding by decompression at the player side. Various artifacts are now visible, e.g. white spots 83 in both the left view and the right view, and blocking effects having boundaries 84 in a grid which is the same in both views. The various artifacts occur at substantially the same location in both views, and will therefore have a specific depth position perceived by a 3D viewer normally at screen depth. The artifacts will “float in the air” at that depth, virtually forming the so-called dirty window.

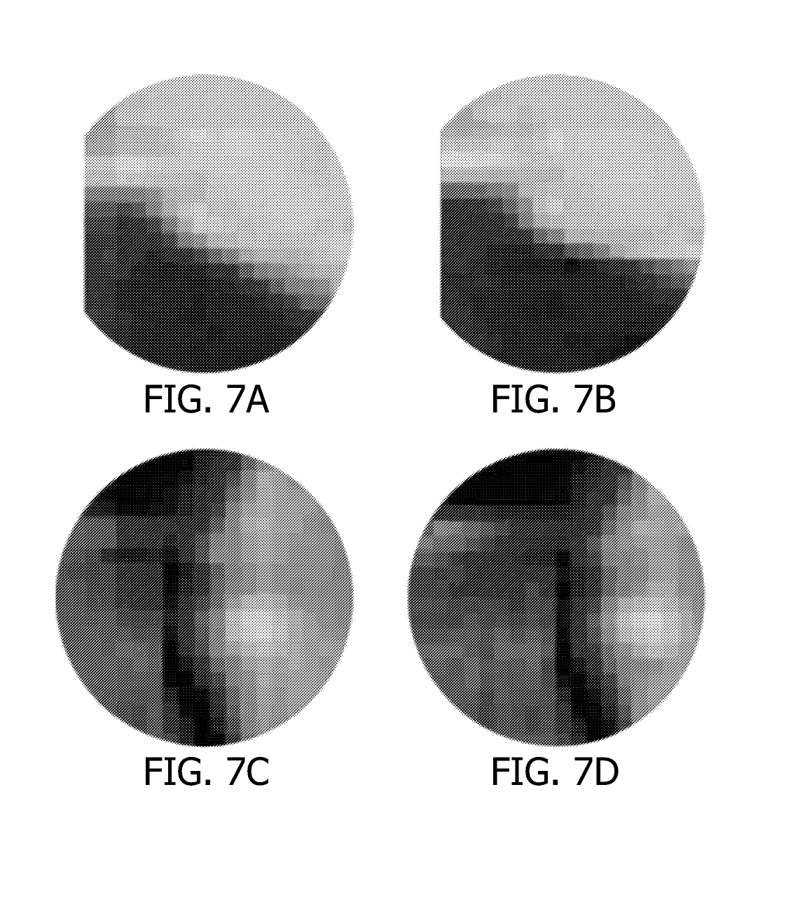

FIG. 7A shows a close-up of the blocking effects having boundaries in a grid 84 of the left view of FIG. 6 and FIG. 7B shows a close-up of the blocking effects having boundaries in a grid 84 of the right view of FIG. 6. Likewise FIG. 7C shows a close-up of the white spots 83 in the left view of FIG. 6 and FIG. 7D shows a close-up of the white spots 83 in the right view of FIG. 6.

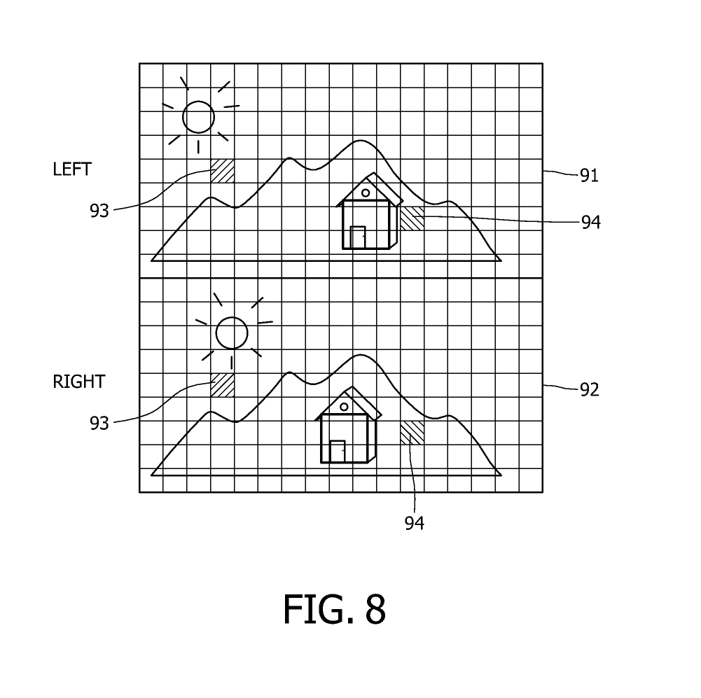

FIG. 8 shows a schematic example of 3D noise. The Figure shows a left view 91 and a right view 92 of a scene having a mountain, a house and the sun. A grid is shown representing the DCT block grid structure as mentioned above. A shift of an object in the R view with respect to the L view to the left with respect to the background means that the object protrudes, e.g. the house is in front of the mountain. The sun is shifted to the right and is perceived at infinity behind the screen. Anything having the same position in the L view and R view has the screen depth. Two coding artifacts 93,94 are made visible, in both the left view and the right view. The first artifact 93 fits in the grid and has the same position in both views, hence floats at screen depth in front of the background mountain. The second artifact 94 also floats at screen depth. Note that in the example the house protrudes in front of the screen. Hence the second artifact appears to be behind the house. Even more disturbing, if such artifact coincides with the area of the house, it appears to be visible in front of the house but has a depth behind it, i.e. seems to be a hole in the house.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate units, processors or controllers may be performed by the same processor or controller. Hence, references to specific functional units are only to be seen as references to suitable means for providing the described functionality rather than indicative of a strict logical or physical structure or organization.

The invention can be implemented in any suitable form including hardware, software, firmware or any combination of these. Although in the above most embodiments have been given for devices, the same functions are provided by corresponding methods. Such methods may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. Method of processing a three dimensional [3D] video signal for avoiding visual disturbances during displaying on a 3D display, the method comprising:
receiving the 3D video signal (41,43) representing 3D video data comprising at least a left view and a right view to be displayed for respective eyes of a viewer for generating a 3D effect,
processing the 3D video data in dependence of at least one amount of visual disturbances to be expected during displaying of the 3D video data on a 3D display (63) due to correlation of coding noise between said views for reducing the correlation of coding noise, and
transferring the processed 3D video data for displaying on the 3D display, wherein the method comprises
determining the at least one amount based on depth differences with respect to a depth position of objects having the same position in the left view and the right view.

2. Method as claimed in claim 1, wherein
the step of determining the at least one amount is for at least one respective block, and the method comprises:
a step of encoding the 3D video data according to a transform based on blocks of video data and encoding parameters for said blocks, and
the step of processing comprises adjusting the encoding parameters for the respective block in dependence of the amount as determined for the respective block.

3. Method as claimed in claim 1, wherein the method comprises:
a step of decoding the 3D video data, and
the step of processing comprises, after said decoding, adding dithering noise to at least one of the views for reducing said correlation.

4. Method as claimed in claim 1, wherein the method comprises generating 3D noise metadata indicative of the at least one amount, and the step of transferring comprises including the 3D noise metadata (33) in a 3D video signal for transferring to a 3D video device for therein enabling processing according to the 3D noise metadata for reducing said correlation of coding noise.

5. Method as claimed in claim 4, wherein the method comprises the step of manufacturing a record carrier, the record carrier (54) being provided with a track of marks representing the 3D video signal having the 3D noise metadata.

6. Method as claimed in claim 1, wherein the method comprises:
retrieving 3D noise metadata from the 3D video signal, the 3D noise metadata being indicative of the at least one amount,
and the step of processing comprises:
processing the 3D video data according to the 3D noise metadata for reducing said correlation of coding noise.

7. 3D video device for processing a three dimensional [3D] video signal for avoiding visual disturbances during displaying on a 3D display, the device comprising:
input means for receiving the 3D video signal representing 3D video data comprising at least a left view and a right view to be displayed for respective eyes of a viewer for generating a 3D effect,
a video processor arranged for processing the 3D video data in dependence of at least one amount of visual disturbances to be expected during displaying of the 3D video data on a 3D display due to correlation of coding noise between said views for reducing said correlation of coding noise, and
transfer means for transferring the processed 3D video data for displaying on the 3D display, wherein the video processor is arranged for
determining the at least one amount based on depth differences with respect to a depth position of objects having the same position in the left view and the right view.

8. 3D video device (40) as claimed in claim 7, wherein the device comprises:
an encoder (48) for encoding the 3D video data according to a transform based on blocks of video data and encoding parameters for said blocks, and
the video processor (42) is arranged for said determining the at least one amount for at least one respective block, and
for, in said processing, adjusting the encoding parameters for the respective block in dependence of the amount as determined for the respective block.

9. 3D video device (50) as claimed in claim 7, wherein the device comprises a decoder (21) for decoding the 3D video data, and the video processor (52) is arranged for, after said decoding, adding dithering noise (24,25) to at least one of the views for reducing said correlation.

10. 3D video device (50) as claimed in claim 9, wherein the video processor (52) is arranged for, after said decoding, adding dithering noise (24) only to the view (L) for the not dominant eye of the viewer.

11. 3D video device (50) as claimed in claim 7, wherein the video processor (53) is arranged:
for retrieving 3D noise metadata from the 3D video signal (41), the 3D noise metadata being indicative of the at least one amount, and
for said processing by processing the 3D video data in dependence of the 3D noise metadata for reducing said correlation.

12. 3D video device as claimed in claim 7, wherein the input means comprise means for reading a record carrier for retrieving the 3D video signal.

13. 3D video signal, the 3D video signal comprising 3D video data comprising at least a left view and a right view to be displayed for respective eyes of a viewer for generating a 3D effect and 3D noise metadata (33) indicative of at least one amount of visual disturbances to be expected during displaying of the 3D video data on a 3D display due to correlation of coding noise between said views, the signal being for transferring the 3D video data to a 3D video device for therein enabling processing the 3D video data according to the 3D noise metadata for reducing said correlation of coding noise, wherein the at least one amount is based on depth differences with respect to a depth position of objects having the same position in the left view and the right view.

14. Record carrier (54) comprising the 3D video signal as claimed in claim 13.

15. Computer program product for processing a three dimensional [3D] video signal for avoiding visual disturbances during displaying on a 3D display, which program is operative to cause a processor to perform the respective steps of the method as claimed in claim 1.
